(19) United States
(12) Patent Application Publication
(10) Pub. No.: US 2006/0095297 A1
(43) Pub. Date: May 4, 2006

(54) Skin assessment kiosk

(76) Inventor: Ravinder S. Virik, Frisco, TX (US)

Correspondence Address: Michael A. O'Neil;Michael A. O'Neil, P.C., Suite 820, 5949 Sherry Lane, Dallas, TX, 75225, US

(21) Appl. No.: 11/247,730

(22) Filed: Oct. 11, 2005

Related U.S. Application Data
(60) Provisional application No. 60/623,253, filed on Oct. 29, 2004.

(51) Int. Cl. G06Q 10/00; G06Q 50/00

(52) U.S. Cl. 705/2

(57) ABSTRACT

A kiosk provides topical skin assessment surveys and skin care selection. The topical skin assessment survey is performed by a self-guided interactive program using a plurality of UVA lamps which illuminate trouble spots on the skin that cannot be seen in a natural light environment. In addition to a topical skin assessment survey, the kiosk provides price comparison of available cosmetic and skin-care products, and the option to purchase products.

### CLAIM OF PRIORITY

This application claims priority of prior provisional Application Ser. No. 60/623,253 filed Oct. 29, 2004, the entire content of which is incorporated herein by reference.

### TECHNICAL FIELD

This invention relates generally to skin care and, in particular, to a skin assessment kiosk which provides topical observations of human facial skin in order to identify problem areas of the skin and assist the user in selecting skin care products to address the identified problems.

### BACKGROUND AND SUMMARY OF THE INVENTION

A multitude of skin care products are available in the marketplace. Currently, most persons seek professional medical assistance, seek help from a cosmetologist or beautician, or self medicate to address skin care problems. Each of these remedies has drawbacks: medical professionals can be costly and may not always be covered by health insurance; an evaluation by a cosmetologist may result in recommendations to buy more products than necessary or affordable; and self-treatment may result in using incorrect, ineffective, or harmful products, which can adversely affect the skin condition.

The present invention comprises a skin assessment kiosk which overcomes the foregoing and other difficulties which have long since characterized the prior art. In accordance with the broader aspects of the invention, a skin assessment kiosk comprises a housing having a plurality of UVA lights that are illuminated during a skin assessment survey during which a user is guided by an interactive software program through a series of steps to observe and identify skin care problems. The results of the survey enable the user to better choose products to address identified skin problems.

In accordance with the more specific aspects of the invention, a housing comprises commercially available Ultra-Violet Type-A (UVA) black light and an interactive touchscreen. As compared with either natural or conventional artificial light, UVA light effectively identifies skin trouble spots. An interactive software program guides the user through a series of steps which identify the topical skin problems of and around the user's face and neck. Various skin problems are illuminated differently by the UVA lights. Each step of the survey is designed to identify a different skin problem. Instructions displayed on a touchscreen during each step assist the user in identifying which portions of the face are illuminated by the UVA lights. The user denotes on the touchscreen which area is illuminated and proceeds to the next step.

At the conclusion of the survey the results are summarized and displayed on the touchscreen including identified skin problems and a list of recommended products to address the identified problems. The user may thereafter utilize the interactive software's capabilities for comparing brands and prices. The user may then elect to purchase products through the kiosk, or receive a physical summary and list of recommended products for further reference. The user may elect to receive the physical summary either through a printer provided with the kiosk, or by inputting an e-mail address for receiving an electronic message comprising the results. Both the product comparison and purchase capabilities of the software may be utilized without taking a topical skin survey.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a skin assessment kiosk comprising a first embodiment of the present invention;

FIG. 2 is a perspective front view of a skin assessment comprising a second embodiment of the present invention;

FIG. 3 is a perspective back view of the kiosk shown in FIG. 2;

FIG. 4 is a perspective view of the skin assessment kiosk shown in FIG. 1 configured as a counter-top unit; and

FIG. 5 is a flowchart illustrating the steps of a method of skin analysis utilizing the kiosk of the present invention.

### DETAILED DESCRIPTION

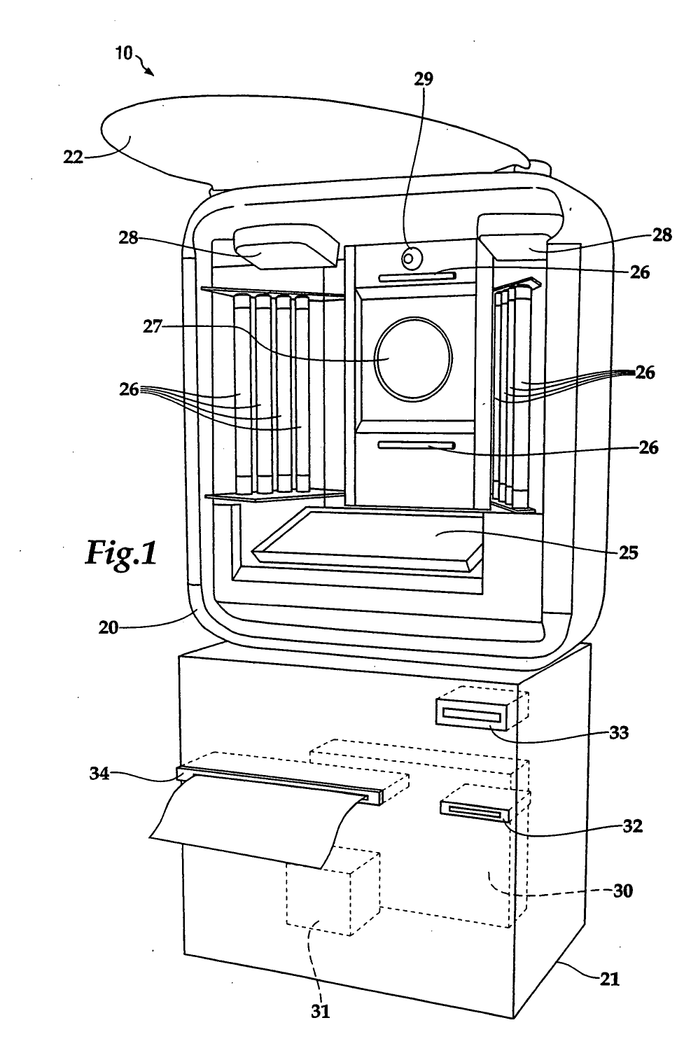

Referring now to the Drawings, and particularly to FIG. 1, there is shown a skin assessment kiosk 10 comprising a first embodiment of the present invention. The kiosk 10 comprises a housing 20 and a base 21. The housing 20 is enclosed on three sides and open to the front. A cover 22 folds down to enclose the front of the housing 20 for security and protection of the kiosk 10. A touchscreen 25 linked with a computing system 30 enables a user to interface with the kiosk 10.

The kiosk comprises an interactive software program supported by the computing system 30. Prompts provided by the software are displayed on the touchscreen 25. The user identifies his/her skin type as normal-to-dry, normal-to-oily, or sensitive and specifies whether the user is currently wearing make-up. The user then selects either a predefined skin assessment survey comprising a series of steps which identify preselected skin care problems or a customized survey whereby the user selects an amount of UVA light illumination time, ranging from about one minute to about three minutes, during which the user may select as many skin problems to identify as time allows. The skin problems available for identification include the following skin problems recognized in the skin care industry: oily skin, clogged pores, dead skin, irregular melanin concentration, dehydration, dry skin, poor circulation, excessive sun exposure, and embryonic wrinkles. If the user identifies that he/she is wearing makeup, the user will only be able to identify the skin problems of excessive and uneven make-up application.

The kiosk 10 comprises a plurality of UVA lights 26 supported within the housing 20 for illuminating the user's face during the selected skin assessment survey. The UVA lights 26 are commercially available 30-Watt bulbs employing black light—blue lamp technology light bulbs that emit Ultra-Violet Type-A light known to those skilled in the art to be safe for human skin in limited amounts of exposure. Once a skin assessment survey begins, the UVA lights 26 illuminate for a predetermined period of time during which the user is guided through a series of steps displayed on the touchscreen 25. The UVA lights 26 illuminate each skin problem in a different way. At each step of the skin assessment survey the user identifies which portion of the face is illuminated by the UVA lights 26. A mirror 27 provides a reflection at least three-times (3×) the size of the reflected image. Alternative to 3× magnification the kiosk may employ a mirror providing at least 5× magnification. The magnification provided by the mirror 27 enables the user to better identify problem areas as compared to a reflection without magnification.

The housing 20 is further equipped with fans 28 for removing heat generated by the UVA lights 26. The fans 28 are located above the UVA lights 26 as shown in FIG. 1, or alternatively may be located behind the mirror 27. A security camera 29 records images of activities occurring within the kiosk 10 while the kiosk 10 is not in use. While the kiosk 10 is occupied the security camera 29 stops recording data except when the user requests a photograph of his/her face during the skin assessment survey. The camera 29 is a commercially available web cam capable of linkage to a remote location.

The computing system 30 is housed within the base unit 21 along with a system performance diagnostics module 31 which monitors system performance of the kiosk 10. In the unlikely event that a malfunction occurs during the skin assessment survey the diagnostics module 31 sends a signal to the computer system 30 for further processing and prepares a refund to the user. The kiosk 10 further comprises a cash acceptor 32 and a credit card reader 33 for accepting payment directly into the base 21 of the kiosk 10.

At the end of a skin assessment survey the software generates a summary for the user which lists the problems identified and corresponding recommendations for products to care for or correct the skin problems. The summary is displayed for the user on the touchscreen 25 whereby the user may select a physical printout utilizing either a printer 34 provided in the base 21 or by providing an e-mail address for receiving the results via an electronic mail message. In addition to skin assessment survey results, the printer 34 is available to print product comparison summaries, product recommendations, and receipts for product orders entered at the kiosk.

The housing 20 and base unit 21 are constructed of wood, metals, rigid plastics, or other materials known to those skilled in the art as suitable for housing and supporting the components of the kiosk 10 described herein. All of the components housed within the base 21 are commercially available for use in retail kiosk and customer interface stations.

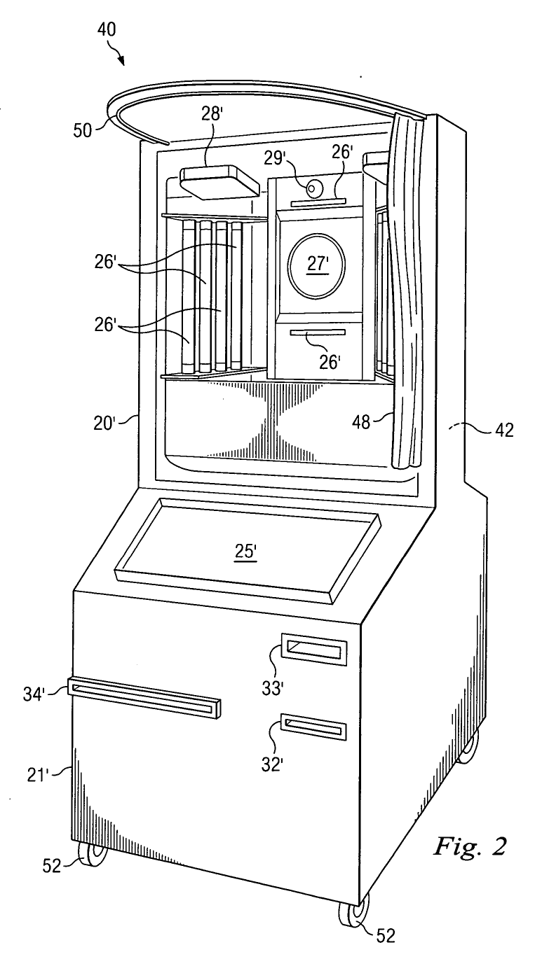

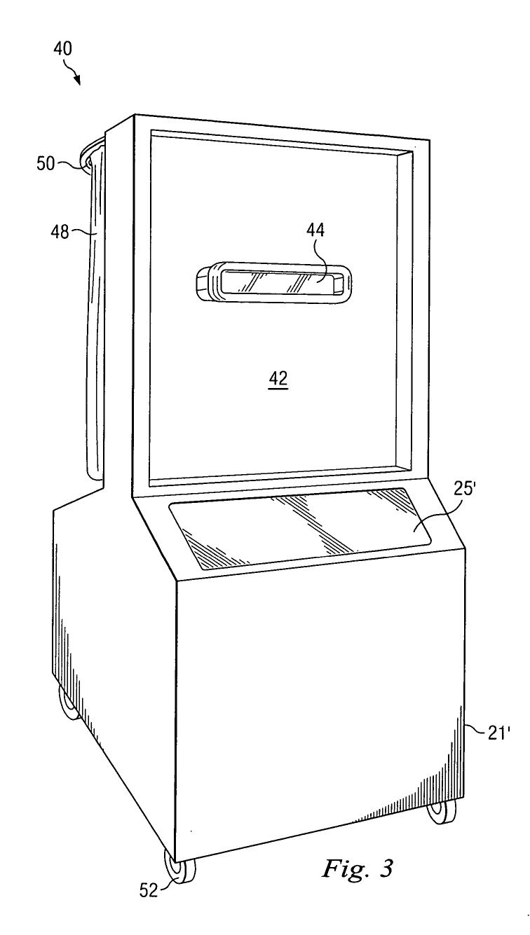

Referring now to FIGS. 2 and 3, there is shown a skin assessment kiosk 40 comprising a second embodiment of the present invention. Many of the component parts of the kiosk 40 are substantially identical in construction and function to component parts of the kiosk 10 illustrated in FIG. 1 and described hereinabove in conjunction therewith. Such identical component parts are designated in FIG. 2 with the same reference numerals utilized above in the description of the kiosk 10, but are differentiated therefrom by means of a prime (′) designation.

The kiosk 40 comprises a secondary interface 42 located on the rear side of the housing 20′. The secondary interface 42 comprises a viewing portal 44 through which a second person can view the user's face and a second touchscreen 46 for interacting with the kiosk 40 during the steps of a skin assessment survey. The second person will be either a trained cosmetic professional, friend, or other person assisting the user during the skin assessment survey. Unless the user interacting with the kiosk 40 enables the secondary interface 42 through the touchscreen 25′ before the series of skin assessment steps begins, the viewing portal 44 is disabled. The kiosk 40 may be used in conjunction with cosmetic counters, women's health expositions, standing independently in a shopping venue, or any other venue where a person is likely to desire a skin assessment survey. Wheels 52 mounted beneath the kiosk 40 enable the kiosk 40 to be moved from one location to another.

The kiosk 40 further comprises a curtain 48 supported by a curtain rod 50. The curtain 48 is pulled behind the user's head during the series of skin assessment steps to prevent interference from flourescent lighting and the like with illumination of the user's face by the UVA lights 26′.

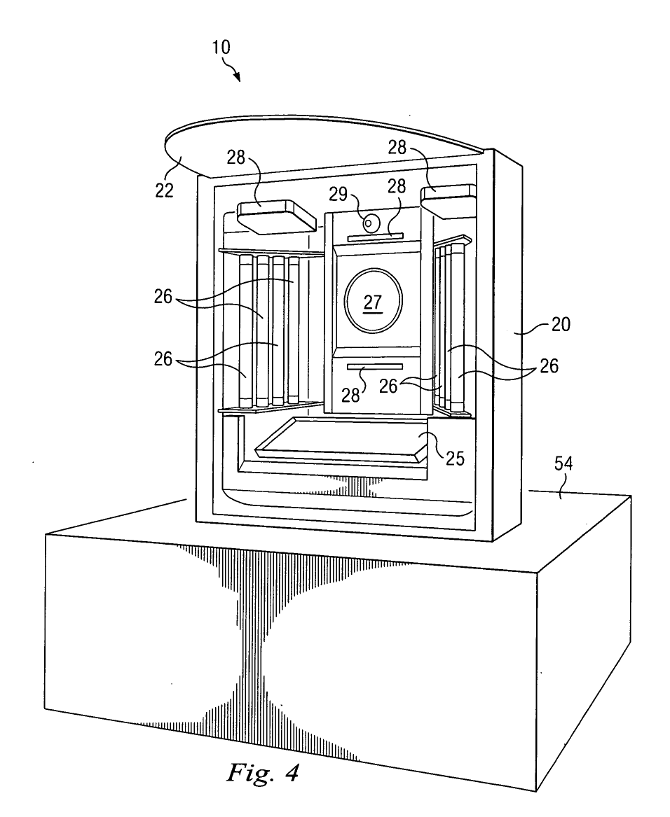

Referring now to FIG. 4, there is shown a kiosk 10 configured as a counter-top unit placed upon a support surface 54 such as a counter, a table, or the like. Because the kiosk 10 does not comprise the base 21, the computing system is incorporated into the housing 20 beneath the touchscreen 25, or alternately set up independently from the housing 20 with wireless connections established therebetween. As will be understood by those skilled in the art, the kiosk 40 illustrated in FIGS. 2 and 3 may also be configured as a stand-alone unit.

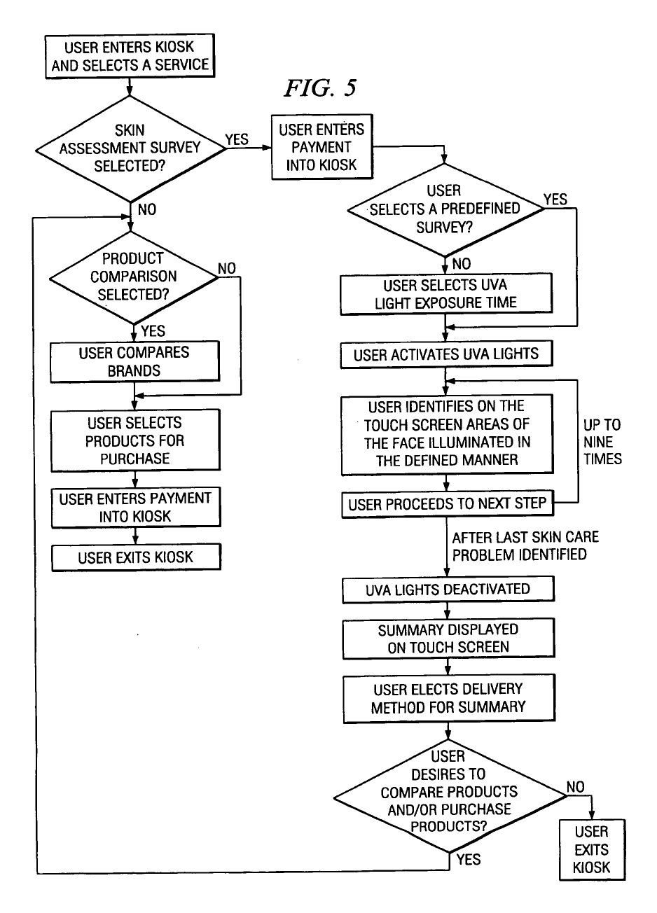

FIG. 5 comprises a method of skin analysis utilizing the kiosk of the present invention. A user engages the kiosk by selecting a service. The user may select a skin assessment survey, select a product comparison, or buy products from the kiosk. If the user elects a skin assessment survey, a product comparison and the opportunity to buy products become available at the conclusion of the survey. If the kiosk is a stand-alone unit as shown in FIGS. 1 through 3, the user pays for the selected service utilizing either the cash acceptor or the credit card machine provided in the base of the kiosk. If the kiosk is a counter-top unit as shown in FIG. 4, the user will provide payment for use of the kiosk to the merchant providing the kiosk, for example, a cosmetic merchant in a department store.

After the user has selected a skin assessment survey, the user chooses from among a list of predefined surveys, or selects a customized survey whereby the user determines an amount of UVA light illumination time, ranging from about one minute up to about three minutes, during which the user may select as many skin problems to identify as time allows. In the example described herein, the user selects a predefined survey identifying the following five skin care problems: clogged pores, oiliness, dehydration, dead skin, and poor circulation. Once the survey has been selected the interactive software program guides the user through the selected survey. The first step prompts the user to turn on the UVA lights. The next step presents the first of five skin problem identifications, i.e., clogged pores. The user identifies which areas of his/her face appear bright orange or yellow under the UVA lights and indicates the areas on a facial diagram provided on the touchscreen. The user then proceeds to the next step, wherein the user identifies areas of the face having oiliness by indicating which areas of the face are illuminated with red patches. The user continues through the remaining steps in the same manner. The remaining skin care problems are illuminated by the UVA lights as follows: dehydration areas appear as a light purple glow with white shades; dry skin appears as a bright white glow; areas with poor circulation are surrounded by a dark purple circular patches; dead skin appears as bright white flakes; irregular melanin concentration appears as brown or coral patches or spots; excessive sun exposure appears as dark purple patches or spots; and embryonic wrinkles indicating future wrinkles appear as gray lines. In the event the user is wearing make-up, he/she will only be able to identify areas having excessive or uneven make-up application, which appear as a deep purple glow.

At the conclusion of the survey the UVA lights turn off and a summary providing the results of the survey is displayed on the touchscreen. The user may elect to print the summary at the kiosk or enter an e-mail address to received the survey by an electronic mail message. The user then proceeds either to a brand and price comparison menu or a menu whereby the user can select products for purchase.

Although the skin assessment kiosk and method of skin analysis as described herein identify ten specific skin care problems, additional diagnostics may be incorporated into the software provided with the kiosk to identify other topical skin problems. The skin assessment kiosk and method of skin analysis as described herein may also be used to identify skin problems of the user's neck and hands.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. For providing cosmetic and skin care services, a kiosk comprising:
a housing;
an interactive software program for directing a user through a series of steps comprising a topical observation and survey of the user's facial skin;
computer hardware means supporting the interactive software program;
means for interfacing with the kiosk;
the interface means mounted on the housing;
a plurality of UVA lights mounted within the housing;
the UVA lights being illuminated during the series of steps directed by the interactive software program;
wherein the series of steps provided in the interactive software program includes directions enabling the user to identify predefined skin problems when prompted by instructions on the interface means;
a mirror providing a magnified reflection of the user's skin during the series of steps; and
means for documenting the results of the topical observation and survey.

2. The kiosk according to claim 1 wherein the interface means is a touchscreen.

3. The stand-alone kiosk according to claim 1 wherein the documenting means is a printer.

4. The stand alone kiosk according to claim 1 wherein the documenting means includes an electronic mail message.

5. The kiosk according to claim 1 further comprising means for visually recording the series of steps.

6. The kiosk according to claim 5 wherein the visual recording means is a camera mounted above the mirror.

7. The kiosk according to claim 6 wherein the camera further provides security monitoring of the kiosk.

8. The kiosk according to claim 6 wherein the camera further provides means for taking a photograph of a user's face while the UVA lights are illuminated.

9. The kiosk according to claim 1 further comprising means for directing heat generated by the UVA lights from the kiosk.

10. The kiosk according to claim 9 wherein the means for directing heat from the kiosk comprises a plurality of fans.

11. The kiosk according to claim 1 further comprising an interactive base, the interactive base comprising:
printing means for printing the results of the topical observation and survey;
means for accepting payment for the service(s) selected from the kiosk; and
computer means for monitoring system performance.

12. The kiosk according to claim 11 wherein the interactive base further comprises the computer hardware means supporting the interactive software program.

13. The kiosk according to claim 1 wherein the interactive software program further enables the user to compare available skin-care and cosmetic products.

14. The kiosk according to claim 13 wherein the user can purchase products using the interactive software program.

15. The kiosk according to claim 1 further comprising:
a secondary interface for use by a person assisting the kiosk user;
the secondary interface enabled by a prompt from the kiosk user before beginning a survey;
a viewing portal through which the assistant can view the kiosk user's face during a survey;
a second touchscreen enabling the assistant to interface with the kiosk during the survey; and
wherein the secondary interface is disabled when the steps of the survey are completed.

16. A method for performing a topical survey of a person's facial skin comprising the steps of:
a. providing a skin assessment kiosk having a plurality of UVA lights, a mirror, and means for interacting with the kiosk;
b. providing an interactive software program for displaying instructions for using and interacting with the kiosk on the interactive means;
c. selecting a topical skin survey;
d. the survey comprising steps for identifying a plurality of skin problems;
e. activating the UVA lights utilizing a command displayed on the interactive means;
f. observing areas of the facial skin having a defined skin problem illuminated by the UVA lights in a designated color utilizing the mirror;
g. identifying the illuminated areas on the interactive means;
h. repeating steps f. and g. for the remaining skin problems to be identified;
i. viewing a summary of the survey results on the interactive means;
j. selecting a method for receiving the summary from the group consisting of receiving a printout and receiving an electronic mail message.

17. The method according to claim 16 further comprising the step utilizing a the interactive software to compare products recommended by the summary.

18. The method according to claim 16 further comprising the step utilizing a the interactive software to purchase products from the kiosk.
